(19) United States
(12) Patent Application Publication
(10) Pub. No.: US 2003/0149573 A1
(43) Pub. Date: Aug. 7, 2003

(54) Product registration system

(76) Inventor: Todd M. Lynton, Winchester, MA (US)

Correspondence Address: POLAROID CORPORATION, PATENT DEPARTMENT, 1265 MAIN STREET, WALTHAM, MA, 02451, US

(21) Appl. No.: 10/067,442

(22) Filed: Feb. 4, 2002

(51) Int. Cl. G06F 17/60

(52) U.S. Cl. 705/1

(57) ABSTRACT

Techniques are disclosed for registering a device without requiring information identifying the user. The device's user provides input to the device that does not include information identifying the user. Such input may, for example, be a single action such as the pressing of a button on the device. In response to the user input, the device transmits a registration request message to a registration server. The registration server receives the registration request message and, in response, registers the device. The registration server may transmit a registration confirmation message to the device to confirm that registration has occurred successfully. Registration may include registering the device with the device's manufacturer or registering the device for use with a service, such as an online printing service.

### CROSS REFERENCE TO RELATED APPLICATIONS

This application is related to the following commonly-owned patent applications, each of which is hereby incorporated by reference in its entirety:

Ser. No. 09/870,536, Atty. Dkt. No. 8501 filed on May 30, 2001, entitled “Method and System for Remote Utilizing a Mobile Device to Share Data Objects”;

Ser. No. 09/870,538, Atty. Dkt. No. 8505 filed on May 30, 2001, entitled “Method and System for Generating a Permanent Record of a Service Provided to a Mobile Device”;

Ser. No. 09/870,561, Atty. Dkt. No. 8504 filed on May 30, 2001, entitled “Method and Apparatus for Printing Remote Images Using a Mobile Device and Printer”;

Ser. No. 10/022,924, Atty. Dkt. No. 8521 filed on Dec. 18, 2001, entitled “Method and Apparatus for Printing Remote Images Using a Network-Enabled Printer”; and

Ser. No. 10/023,245, Atty. Dkt. No. 8522 filed on Dec. 18, 2001, entitled “Method and System for Generating a Permanent Record of a Service at a Remote Printer.”

### BACKGROUND

1. Field of the Invention

The present invention relates to techniques for product registration and, more particularly, to techniques for registering products remotely over a communications network.

2. Related Art

There is an increasing demand for mobile computing devices and for devices with (wired and wireless) network communication capabilities. For example, both cellular telephones and mobile computing devices such as personal digital assistants (PDAs) are becoming increasingly widespread. Furthermore, small and lightweight mobile printers are becoming increasingly popular to facilitate printing of images and other information from a variety of locations. One reason that these devices are useful is that they may easily be transported and therefore used from locations other than the user's primary office or home, unlike conventional desktop computers and computer peripherals, which are typically fixed in a particular location.

When a consumer purchases a computing product, such as a computer, printer, modem, or software package, it is often necessary or desirable for the consumer to register the product with the product's manufacturer before the first use of the product. Registration of such a product typically requires the product owner to provide personal identifying information—such as the owner's name, address, and telephone number—on a printed form that is mailed or faxed to the manufacturer, or on a web-based form that is transmitted to the manufacturer over the World Wide Web. Similarly, users are typically required to register with online services, such as web-based services for purchasing event tickets, downloading electronic coupons, or storing digital photographs in online albums, before first using such services. Such registration processes typically require the user to provide personal identifying information similar to that required for product registrations.

When registering to use online services, users are also typically required to create a personal account with the online service. To create such an account, the user typically must provide both a unique identifier—such as an alphanumeric login name—and a password. Each time the user wishes to access his or her account, the user must provide the correct login name and password. Once the user has logged in to the account in this manner, the user may use the services associated with the account, such as sending and receiving email or storing digital photographs.

The registration processes described above can be tedious and time-consuming for users for a variety of reasons. For example, as described above, product registration typically requires the user to provide a variety of personal identifying information to the manufacturer or service provider. The user must typically handwrite or type such information, which can be tedious and time-consuming. Furthermore, registration with online services is itself typically performed online. Such registration therefore requires that the user have access both to an Internet connection and to a device having a keyboard (or other input component) for providing the personal identifying information during the registration process.

In addition to being time-consuming, such a registration process may therefore be difficult or impossible to perform using only a mobile device—such as a mobile printer—that has no keyboard. As a result, the user must typically use a conventional desktop or laptop computer having an Internet connection to register such a mobile device before its first use. Requiring the user to locate, travel to, and use a fixed (non-mobile) computer to register a mobile device is contrary to the goal of enabling the user to purchase the mobile device and immediately begin using the device from any location.

What is needed, therefore, are techniques for simplifying the process of product registration, particularly in the case of mobile devices.

### SUMMARY

In one aspect of the present invention, a computer-implemented method is provided for registering a device without requiring information identifying the user of the device. The device's user provides input to the device that does not include information identifying the user. Such input may, for example, be a single action such as the pressing of a button on the device. In response to the user input, the device transmits a registration request message to a registration server. The registration server receives the registration request message and, in response, registers the device. The registration server may transmit a registration confirmation message to the device to confirm that registration has occurred successfully. The registration process may include registering the device with the device's manufacturer or registering the device for use with a service, such as an online printing service. The registration server may determine whether the device is already registered and only register the device if it is not already registered.

The registration process performed by the registration server may include steps of obtaining an identifier of the device (a “device ID”) and registering the device based on the device ID. For example, in one embodiment, the registration request message transmitted by the device includes the device ID, in which case the registration server may obtain the device ID from the registration request message. In another embodiment, the registration server obtains a device ID by assigning a device ID to the device. The registration server may also transmit the assigned device ID to the device, and the device may record the device ID.

The registration request message may be a message specifically requesting that the device be registered. Alternatively, the registration request message may be a message requesting initiation of a transaction with a service, in which case the registration server may register the device if the registration request message indicates that the device is not already registered.

The process of registration performed by the registration server may include recording the device ID at the server and/or device. The process of registration may also include creating an account for use by the device with a service, such as an online service for purchasing tickets. The account may be associated with the device ID.

Additional aspects and embodiments of the present invention and advantages thereof will be described in more detailed below.

### BRIEF DESCRIPTION OF THE DRAWINGS

FIG. 1 is a block diagram of a system for registering a device for use with a online service according to one embodiment of the present invention.

FIG. 2 is a data flow diagram of a process that is used by the system of FIG. 1 to register a device according to one embodiment of the present invention.

### DETAILED DESCRIPTION

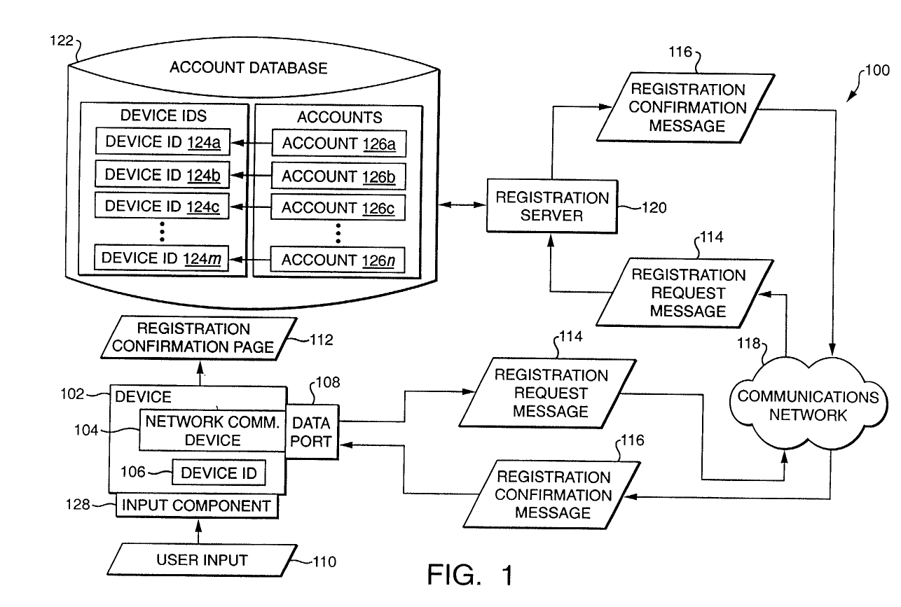

Referring to FIG. 1, a system 100 is shown which is used to register a device 102 in one embodiment of the present invention. The device 102 may, e.g., be registered with the device's manufacturer and/or be registered for use with a service, such as an online service for printing tickets, coupons, or other information. The device 102 may, for example, be a mobile printer, Personal Digital Assistant (PDA), or cellular telephone. The device 102 includes a network communications device 104 (such as a modem) for communicating over a communications network 118 (such as the Internet) through a data port 108.

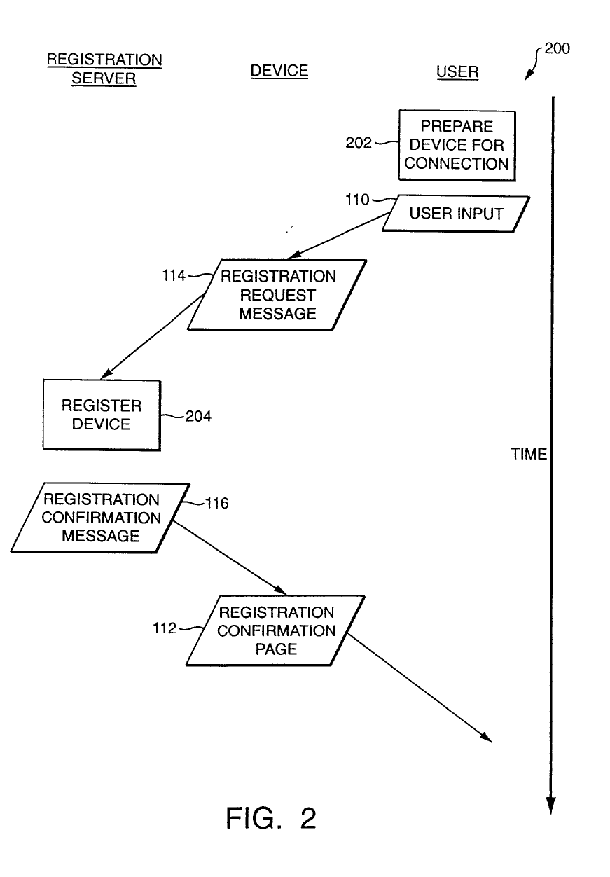

Referring to FIG. 2, a dataflow diagram is shown of a method 200 that is used to register the device 102 according to one embodiment of the present invention. FIG. 2 illustrates actions performed by and information transmitted among the device 102, a user of the device (not shown), and a registration server 120 that registers the device 102. More specifically, diagram 200 includes three columns, corresponding to the registration server 120, device 102, and user, respectively. An action performed by one of these elements is indicated by a rectangle in the corresponding column, and information transmitted by the element is indicated by a non-rectangular parallelogram in the corresponding column. A message transmitted by a first element to a second element is indicated by a parallelogram describing the message in the first component's column, connected to an arrow ending in the second component's column. FIG. 2 has a time axis which runs downward, indicating the sequence in which actions are performed and information transmitted. The description of FIG. 2 below will further clarify the dataflow diagram shown therein.

After purchasing or otherwise obtaining the device 102, the user prepares the device 102 to connect to the communications network 118 (step 202). For example, in one embodiment, the network communications device 104 is a modem, the data port 108 is a modem port, and the communications network 118 is the Internet. To prepare the device 102 to connect to the communications network 118, the user may connect the data port 108 to a standard telephone jack using a standard telephone cable, as described in more detail in the above-referenced application entitled “Method and Apparatus for Printing Remote Images Using a Network-Enabled Printer.” In another embodiment, the user may prepare the device 102 to be connected to the communications network 118 by connecting the device 102 (through its data port 108) to an Internet-enabled cellular telephone (not shown), as described in the above-referenced application entitled “Method and Apparatus for Printing Remote Images Using a Mobile Device and Printer.”

As described in more detail in the above-referenced patent applications, the device 102 need not include the network communications device 104 (such as a modem). If, for example, the device 102 does not include the network communications device 104, the device 102 may be a “dumb” device that is not itself directly capable of communicating over the communications network 118, but which may connect to the communications network 118 through an external network communications device such as a cellular telephone.

The user then provides input 110 to the device 102. The input 110 may, for example, be a single action performed by the user, such as the pressing of a single button on the device 102. In one embodiment, for example, in which the device 102 is a printer having a “Print” button, the user provides user input 110 by pressing the “Print” button. In various embodiments of the present invention, the user input 110 does not include information identifying the user, such as the user's name or address.

In response to receiving the user input 110, the device 102 initiates a logical connection to the registration server 120 over the communications network 118 and transmits a registration request message 114 to the registration server 120 over the communications network 118. In various embodiments of the present invention, the registration request message 114 does not include information identifying the user, such as the user's name or address. Several embodiments of the registration request message 114 are described in more detail below.

The device 102 may establish a connection to the registration server 120 in any of a variety of ways. For example, the device 102 may be pre-configured with a telephone number of the registration server 120, in which case the device 102 may use the network communications device 104 (e.g., modem) to dial the registration server's telephone number over a telephone network and establish a logical connection with the registration server 120 using techniques that are well-known to those of ordinary skill in the art.

As described in more detail below, the registration request message 114 may, for example, be a message that specifically requests that the device 102 be registered. The device 102 may, for example, to be configured to transmit such a message to the registration server 120 the first time the device 102 establishes a connection to the registration server 120. Alternatively, the registration request message 114 may be a message that does not specifically request that the device 102 be registered, but rather be any message transmitted to the registration server 120, such as a message that requests initiation of a transaction with a service associated with the registration server 120. The registration server 120 may register the device 102 in response to receipt of such a message if the registration server 120 determines that the message was transmitted by a device that is not already registered with the associated service. Techniques that the registration server 120 may use to make such a determination are described in more detail below.

The registration server 120 registers the device 102 in response to receiving the registration request message 114 (step 204). Although various embodiments of the registration process will be described in more detail below, it should be noted that the registration process need not require the use of information identifying the user, such as the user's name or address. Furthermore, the registration server 120 may first determine whether the device 102 is registered and only register the device 102 if it is not already registered, as described in more detail below.

The registration server 120 may register the device 102 (step 204) by obtaining an identifier of the device 102 and registering the device based on the device identifier (“device ID”). Examples of various ways in which the registration server 120 may obtain such a device ID are described in more detail below. Once the registration server 120 obtains a device ID for the device 102, the registration server 120 may record the device's device ID for future use. The registration server 120 may, for example, maintain or otherwise have access to an account database 122 that stores records of accounts 126a-n with a corresponding service, where n is the number of accounts. Use of such accounts is described in more detail in the above-referenced application entitled “Method and System for Remote Utilizing a Mobile Device to Share Data Objects.” In one embodiment, the accounts 126a-n are associated with device IDs 124a-m (where m is the number of device IDs). Each of the device IDs 124a-m is the device ID of a device such as the device 102. Although there may be the same number of device IDs as accounts (e.g., m may be equal to n), this is not required.

Upon registering the device 102, the registration server 120 optionally transmits a registration confirmation message 116 to the device 102, confirming that the device 102 has been successfully registered. The device 102 prints or otherwise outputs a registration confirmation page 112 to the user. The registration confirmation page 112 may, for example, be a printed page informing the user that registration has been performed successfully.

Having generally described the operation of the system 100, various embodiments of the present invention will now be described in more detail. In one embodiment, the device 102 is pre-configured by the manufacturer with a unique device identifier (ID) 106. In such an embodiment the system 100 is said to be a “pre-identified” registration system, because devices are “pre-identified” with device IDs by the manufacturer prior to registration. The device identifier 106 may, for example, be stored in firmware or other memory of the device 102.

In a pre-identified registration system, the device 102 may include its device ID 106 in the registration request message 114 that it transmits to the registration server 120. The registration server 120, upon receiving the registration request message 114, may obtain the device ID 106 from the registration request message 114. The registration server 120 may determine whether the device 102 is already registered by comparing the device ID 106 to the device IDs 124a-m stored in the account database 122. If the device ID 106 obtained from the registration request message 114 is already among the device IDs 124a-m in the account database 122, the registration server 120 need not register the device 102 in step 204 (FIG. 2). If the device ID 106 in the registration request message 114 is not among the device IDs 124a-m in the account database 122, the registration server 120 may register the device 102 (i.e., perform step 204). The registration server 120 may perform such registration by, for example: (1) adding the device ID 106 to the device IDs 124a-m in the account database 122; (2) creating a new account in the account database 122; and (3) associating the new account with the device ID 106.

As described above, the registration server 120 may optionally send a registration confirmation message 116 to the device 102 upon completion of registration. Alternatively, the user may obtain the device ID 106 from a sticker placed on the device 102 by the manufacturer or from other documentation provided with the device 102.

In another embodiment, the device 102 includes a memory (such as a PROM) for storing the device ID 106, but is configured by the manufacturer to have a device ID that is null or that otherwise indicates that a device ID has not yet been assigned to the device 102. In such an embodiment the system 100 is said to be a “post-identified” registration system because the device ID 106 is assigned a value during the registration process, after the device 102 has been manufactured and purchased.

In a post-identified registration system, the device 102 may omit the device ID 106 from the registration request message 114 or otherwise indicate that a device ID has not yet been assigned to the device 102. In a post-identified registration system, the registration server 120 may, upon receipt of the registration request message 114, examine the registration request message 114 to determine whether it specifies a device ID for the device 102. If the registration request message 114 does not include a device ID, the registration server 120 may determine that the device 102 is not yet registered and assign an identifier to the device 102. The registration server 120 may assign a device ID to the device 102 by, for example: (1) generating a new device ID (e.g., by adding a unique device ID to the device IDs 124a-m); (2) creating a new account in the account database 122; and (3) associating the new account with the new device ID. The registration server 120 may then record the assigned device ID and transmit it to the device 102 using the registration confirmation message 116. The device 102 may record the device ID as the device's device ID 106, and output the registration confirmation page 112 informing the user of the device ID 106 and other registration-related information.

Registration of the device 102 in the manner described above may be useful for a variety of purposes. For example, the system 100 may register the device 102 for use with a service, such as an online service for printing tickets, coupons, or other information. Use of devices such as printers with such online services is described in more detail in the above-referenced applications, such as the above-referenced application entitled “Method and Apparatus for Printing Remote Images Using a Network-Enabled Printer.”

For example, in one embodiment the device 102 is a mobile printer and the registration server 120 registers the device 102 for use with an online printing service for printing tickets, coupons, and other information. During the registration process described above with respect to FIG. 2, an account associated with the device 102 may be created. If the device 102 is a printer, for example, the device's account may act as a print queue for storing and transmitting documents intended for printing by the device 102. Once registered, the user of the device 102 may engage in transactions with transaction services (such as online services for purchasing tickets) that generate print jobs that may be transmitted to the printing service for printing. The user may then use the device 102 to connect to the device's print queue and automatically download and print all print jobs in the print queue.

Consider, for purposes of illustration, how the registration process described above with respect to FIG. 2 may operate in such a scenario. After the user purchases the device 102, the user may prepare the device 102 to connect to the communications network 118, as described above with respect to step 202 (FIG. 2). The user may then press a “Print” button on the device 102, causing the device 102 to transmit the registration request message 114 to the registration server 120. As described above, this may be either a message specifically requesting that the device 102 be registered, or another message, such as a message requesting that all print jobs in the device's print queue be downloaded to the device 102. In the latter case, the registration server 120 may examine the registration request message 114 and determine that it was transmitted by a device that is not yet registered, either because the registration request message 114 includes a device ID that is not in the account database 122 (in the case of a pre-identified system), or because the registration request message does not include a device ID (in the case of a post-identified system). Upon determining that the device 102 is not registered, the registration server may register the device.

As a result of the registration process, the account database 122 includes an account that serves as a print queue for the device 102. The user then purchases a movie ticket from an online ticketing service. During the ticket purchasing process, the online ticketing service asks the user to select a method of ticket delivery. The user may select “mobile printing” as a delivery method and provide the device ID 106 of the device 102 to identify the printer on which the purchased ticket should be printed. Upon completion of the ticket purchase, a print job for the purchased ticket may be added to the device's print queue, as described in more detail in the above-referenced patent applications. The user may purchase additional tickets and/or engage in other transactions that cause additional print jobs to be added to the device's print queue.

To print the print jobs in the device's print queue, the user may prepare the device 102 to connect to the communications network 118, as described above with respect to step 202 (FIG. 2). The user may then press a “Print” button (which may, for example, be the same button that the user pressed to provide the user input 110 during the registration process) on the device 102, thereby causing the device 102 to connect to the device's print queue over the communications network 118, download all of the print jobs in the device's print queue, and print all of the downloaded print jobs. Various ways in which such downloading and printing may be performed are described in more detail in the above-referenced patent applications.

Various aspects and embodiments of the present invention have various advantages, which include but are not limited to the following.

One advantage of various embodiments of the present invention is that the device 102 may be registered without requiring the user of the device to provide information identifying the user during the registration process. For example, in one embodiment, the user may register the device 102 by preparing the device 102 to connect to the registration server 120 over the communications network 118, and providing user input 110 (such as pressing a single button the device 102) that does not include information identifying the user. In response to providing such user input 110, the device 102 initiates registration with the registration server 120 automatically, as described above with respect to FIG. 2. This represents a significant advantage over conventional registration processes, which often require the user to provide a significant amount of personal identifying information, such as the user's name and address. The ability to perform registration without providing such information simplifies the registration process, enables the registration process to be completed more quickly, and allows registration to be performed even if the device 102 does not have a keyboard or other input component for entering user-identifying information. The device 102 may therefore be smaller and more mobile than devices having keyboards or other complex input components.

A related advantage of the simplified registration process of various embodiments of the present invention is that they may be performed without use of a conventional desktop or laptop computer. Rather, to register the device, the user need only have access to means for establishing a connection between the device 102 and the registration server 120 over the communications network 118. Such means (which may include, for example, a telephone wall jack or Internet-capable cellular telephone to which the device 102 may be connected) are typically more easily accessible and/or mobile than conventional computers having network connections. As a result, the ability to register the device 102 using such means enables the user to purchase the device 102, quickly register the device 102 from any of a variety of locations, and begin using the device without first accessing a conventional computer. This represents an advantage over conventional registration of devices through an Internet-enabled computer or by mail, particularly in the case of devices that cannot be used before they are registered.

Another advantage of various embodiments of the present invention is that they enable the device 102 to be used with a variety of transaction services that use personal information about the user, even though the device registration process itself does not require such information. For example, as described above, the user may engage in transactions with services and identify the device 102 using its device ID. The user may thereby identify the device 102 in transactions with such services solely using its device ID, without needing to provide personal identifying information. The service associated with the registration server 120 may, however, allow the user to provide additional personal identifying information after registration is complete.

A further advantage of various embodiments of the present invention is that the accounts 126a-n need not be created when devices (such as device 102) are manufactured or at any time prior to the first use of such devices. Creating accounts for every device manufactured might use a significant amount of space in the account database 122 even before such space is needed to service devices. Using the techniques described above, accounts may be created for devices upon the first use of such devices, thereby deferring creation of accounts until such accounts are needed for use.

An additional advantage of various embodiments of the present invention is that they enable a single kind of user input to initiate both registration of the device 102 and performance of other actions by the device 102. For example, as described above, in one embodiment the device 102 is a printer having a “Print” button. Pressing the “Print” button before the device 102 is registered may cause the device 102 to be registered, as described above. Pressing the “Print” button after the device 102 is registered may cause the device 102 to download and print information stored in the device's account. As a result, the user of the device 102 need only learn how to perform one simple activity, such as pressing a single button, to both register and use the device 102.

It should be appreciated that the various embodiments described above are provided merely for purposes of example and do not constitute limitations of the present invention. Rather, various other embodiments are also within the scope of the claims, such as the following.

The device 102 may be any device capable of performing the functions described herein. For example, the device 102 may be a printer, scanner, digital camera, Personal Digital Assistant (PDA), cellular telephone, digital media card reader (such as a smart card reader), telematics device (which may, for example, be installed in a motor vehicle), or any combination thereof. Although not shown in FIG. 1, it should be appreciated that the device 102 may include one or more controllers for performing the functions described herein, such as generating the registration request message 114 and the registration confirmation page 112, receiving and interpreting the user input 110, and accessing the device ID 106. Such a controller may, for example, be implemented using hardware, software, firmware, or any combination thereof.

The network communications device 104 may be any network communications device capable of communicating over the communications network 118. Although the network communications device 104 is shown as an component of the device 102, this is not a requirement of the present invention. Rather, the network communications device 104 may either be a component of the device 102 or an external device through which the device 102 connects to the communications network 118. For example, the network communications device 104 may be an internal or external analog or digital modem, or a network interface card (NIC). The data port 108 may be a port of the network communications device 104. The network communications device 104 may be capable of communicating over the communications network 118 through another device, such as a cellular telephone, as described in more detail in the above-referenced patent applications.

The device ID 106 may be any kind of identifier and may be generated and stored in any way. For example, in one embodiment, the manufacturer of the device 102 assigns a unique numeric identifier to each device of the same model as device 102. Such identifiers may, for example, be assigned sequentially. The device ID 106 may be stored in a read-only or rewritable memory accessible to the device 102. The device ID 102 may also be printed or otherwise marked on an exterior surface of the device 102 so that it is visible to the owner of the device 102. Although the initial device ID assigned by the manufacturer or the registration server 120 may be a numerical ID, the user may be provided with the ability to associate a more easily memorable alphanumeric ID with the device 102 at a later time.

The input component 128 may be any component for providing input to the device. It may, for example, be a physical button or a “soft” button displayed by software on a display of the device 102. It may also, for example, be a key, keyboard, or mouse. The input component 128 may be integrated with the physical structure of the device 102, or may be an external input device that is temporarily or permanently coupled to the device 102 by means of a cable or other connection.

The user input 110 may take any of a variety of forms. For example, in one embodiment, the user input 110 is provided by a single action performed by the user, such as a single press of a button. Although the input component 128 is described herein as activating the registration process, the input component 128 may additionally be used for other purposes. For example, if the input component 128 is a “Print” button, pressing the button the first time may cause the device 102 to be registered for use with a service, while subsequent presses may cause the device 102 to download and print information from the service, as described above.

The user input 110 may, furthermore, include more than one action by the user, such as multiple button presses, key presses, or mouse clicks. The user input 110 need not, however, include information identifying the user, such as the user's name or address. If the user input 110 does include any information identifying the user, such information need not be transmitted to the registration server 120 in the registration request message 114. Furthermore, even if information identifying the user is included in the registration request message 114, the registration server 120 need not use such information to register the device 102. The registration server 120 may, for example, use only the device ID 106 and/or other information that does not identify the user to register the device 102, as described above.

As used herein, the terms “information identifying the user” and “personal identifying information” refer to information that identifies a user of the device 106 apart from the device 102 itself. The device ID 106, for example, does not constitute “information identifying the user,” even though the device ID 106 may identify the user indirectly if the user is the sole user of the device 102. Examples of “information identifying the user” include the user's name, address, telephone number, and social security number.

As described above, the device 102 may be registered for use with a “service.” The service may be any kind of service, such as a service for printing information, purchasing tickets, downloading coupons, or sending and receiving email. Although the device 102 is registered over the communications network 118, the service itself need not be accessible over the communications network 118. Rather, the service may be accessible in person, by mail, over a communications network (such as a telephone network or the Internet), or any combination thereof.

The registration server 120 may be implemented in hardware, software, firmware, or any combination thereof. For example, the registration server 120 may be implemented in software executing on a computer accessible over the communications network. The registration server 120 need not be a “server” according to a client-server architecture. Although not shown in FIG. 1, a service for which the device 102 is registered may also employ an account server to manage and access the accounts 126a-n stored in the account database 122 after devices (such as device 102) have been registered for use with the service. Such an account server may be integrated with or distinct from the registration server 120.

In one embodiment, each of the accounts 126a-n is used by the registration server 120 (and/or the account server described above) to manage information and/or services associated with a particular device, such as device 102. Each of the accounts 126a-n maintains a logical link to one of the device IDs 124a-m, which specifies the particular device to which the account corresponds. If, for example, the device ID 106 of the device 102 is the same as device ID 124a in the account database 122, then account 126a stores information associated with device 102. In one embodiment, for example, the device 102 is a printer and the service associated with account database 122 is a service for accumulating print jobs to be printed on the printer. In such an embodiment, the account associated with each printer is linked to the printer's device ID and stores the print jobs that are to be printed by the printer upon its next connection to the account server.

As described above, the registration server 120 may “register” the device 102 for use with a service. The registration process may be performed in any of a variety of ways. For example, as described above, registration may involve generating a device ID for the device 102, storing a device ID for the device 102 in the account database 122, creating an account for the device 102 in the account database 122, transmitting a device ID and other confirmatory information to the device 102, or any combination thereof.

The registration request message 114 may be generated in any manner and be stored and transmitted in any form, and may be transmitted according to any appropriate protocol, such as TCP/IP, WAP, or higher-level protocols that run on top of such protocols.

The registration confirmation message 116 may include any information that confirms registration of the device 102 with the service. For example, in one embodiment, the registration confirmation message 116 simply indicates that the device 102 has been registered and includes the device's device ID 106 if the device ID 106 was assigned to the device 102 during the registration process. The registration confirmation message 116 may also include additional information that may be used to generate the registration confirmation page 112. For example, the registration confirmation page 112 may take the form of a printed page that informs the user that the device 102 has successfully been registered, informs the user of the device's device ID 106, and provides information to the user about how to use the service. In such a case, the registration confirmation message 116 may include the information necessary to generate the registration confirmation 112, such as HTML code or an image file that may be printed as the registration confirmation page 112.

The communications network 118 may be any kind of communications network, such as a private intranet or the public Internet, a Plain Old Telephone Service (POTS) network, or an analog or digital cellular network. The communications network 118 over which the device 102 is registered with the service need not be the same communications network that the device 102 uses to access the service after registration.

The account database 122 may be represented using any appropriate data structure and be stored and accessed in any manner. For example, the account database 122 may be implemented using any relational or non-relational database management system, as a flat file, or as a data structure of a software program in the memory of a computer. Although the account database 122 as illustrated in FIG. 1 includes separate data structures for the device IDs 124a-m and the accounts 126a-n, this is shown merely for purposes of example. Rather, any data structure for performing the functions described herein may be used to record the results of device registration. For example, the device IDs 124a-m and accounts 126a-n may be stored in separate databases, the device IDs may be integrated into the accounts 126a-n, or the account database 122 may solely store the device IDs 124a-m without storing separate accounts 126a-n.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output.

What is claimed is:

1. A computer-implemented method for registering a device, the method comprising steps of:
(A) at the device, transmitting a registration request message to a registration server in response to input provided by a user of the device, wherein the input does not include information identifying the user; and
(B) at the registration server, registering the device in response to receipt of the registration request message.

2. The method of claim 1, wherein the input comprises performance of only a single action by the user.

3. The method of claim 1, wherein the input comprises the pressing of a button on the device.

4. The method of claim 1, wherein the step (B) comprises steps of:
(B)(1) obtaining an identifier of the device; and
(B)(2) registering the device based on the identifier.

5. The method of claim 4, wherein the registration request message includes the identifier of the device, and wherein the step (B)(1) comprises a step of obtaining the identifier from the registration request message.

6. The method of claim 4, wherein the step (B)(1) comprises a step of assigning the identifier to the device, and wherein the method further comprises steps of:
(C) at the registration server, transmitting the assigned identifier to the device; and
(D) at the device, recording the assigned identifier.

7. The method of claim 1, further comprising steps of:
(C) at the registration server prior to the step (B), determining whether the device is registered; and
(D) at the registration server, performing the step (B) only if it is determined in the step (C) that the device is not registered.

8. The method of claim 1, wherein the registration request message comprises a message requesting that the device be registered.

9. The method of claim 1, wherein the step (B) comprises a step of registering the device for use with a service, and wherein the registration request message comprises a message requesting initiation of a transaction with the service.

10. The method of claim 4, wherein the step (B)(2) comprises a step of recording the identifier of the device.

11. The method of claim 4, wherein the step (B)(2) comprises a step of creating an account for use with a service, the account being associated with the identifier of the device.

12. The method of claim 1, further comprising a step of:
(C) at the registration server, transmitting to the device a registration confirmation message confirming the registration performed in the step (B).

13. The method of claim 1, wherein the device comprises a printer.

14. A computer-implemented method performed by a registration server to register a device, the method comprising steps of:
(A) receiving a registration request message from the device, wherein the registration request message does not include information identifying a user of the device; and
(B) registering the device based on the registration request message.

15. The method of claim 14, wherein the step (B) comprises steps of:
(B)(1) obtaining an identifier of the device; and
(B)(2) registering the device based on the identifier.

16. The method of claim 15, wherein the registration request message includes the identifier of the device, and wherein the step (B)(1) comprises a step of obtaining the identifier from the registration request message.

17. The method of claim 15, wherein the step (B)(1) comprises a step of assigning the identifier to the device, and wherein the method further comprises a step of:
(C) transmitting the assigned identifier to the device.

18. The method of claim 15, further comprising steps of:
(C) prior to the step (B), determining whether the device is registered; and
(D) performing the step (B) only if it is determined in the step (C) that the device is not registered.

19. The method of claim 14, wherein the registration request message comprises a message requesting that the device be registered.

20. The method of claim 14, wherein the step (B) comprises a step of registering the device for use with a service, and wherein the registration request message comprises a message requesting initiation of a transaction with the service.

21. The method of claim 14, wherein the step (B) comprises a step of recording the identifier of the device.

22. The method of claim 15, wherein the step (B)(2) comprises a step of creating an account for use with a service, the account being associated with the identifier of the device.

23. The method of claim 14, further comprising a step of:
(C) transmitting to the device a registration confirmation message confirming the registration performed in the step (B).

24. The method of claim 14, wherein the device comprises a printer.

25. A method performed by a device for registering the device, the method comprising steps of:
(A) transmitting a registration request message to a registration server in response to input provided by a user of the device, wherein the input does not include information identifying the user; and
(B) receiving from the registration server a registration confirmation message confirming that the device has been registered.

26. The method of claim 25, wherein the input comprises performance of only a single action by the user.

27. The method of claim 25, wherein the input comprises the pressing of a button on the device.

28. The method of claim 25, wherein the registration request message comprises a message requesting that the device be registered.

29. The method of claim 25, wherein the step (B) comprises a step of registering the device for use with a service, and wherein the registration request message comprises a message requesting initiation of a transaction with the service.

30. The method of claim 25, wherein the device comprises a printer.

31. A system comprising:
a device comprising means for transmitting a registration request message to a registration server in response to input provided by a user of the device, wherein the input does not include information identifying the user; and
a registration server comprising means for registering the device in response to receipt of the registration request message.

32. The system of claim 31, wherein the input comprises performance of only a single action by the user.

33. The system of claim 31, wherein the input comprises the pressing of a button on the device.

34. The system of claim 31, wherein the means for registering the device comprises:
means for obtaining an identifier of the device; and
means for registering the device based on the identifier.

35. The system of claim 34, wherein the registration request message includes the identifier of the device, and wherein the means for obtaining the identifier of the device comprises means for obtaining the identifier from the registration request message.

36. The system of claim 34, wherein the means for obtaining the identifier of the device comprises means for assigning the identifier to the device, wherein the registration server further comprises means for transmitting the assigned identifier to the device, and wherein the device further comprises means for recording the assigned identifier.

37. The system of claim 31, wherein the registration server further comprises means for determining whether the device is registered, and wherein the means for registering the device comprises means for registering the device only if the device is not registered.

38. The system of claim 31, wherein the registration request message comprises a message requesting that the device be registered.

39. The system of claim 31, wherein the step (B) comprises a step of registering the device for use with a service, and wherein the registration request message comprises a message requesting initiation of a transaction with the service.

40. The system of claim 34, wherein the means for registering the device for use with the service based on the identifier comprises means for recording the identifier of the device.

41. The system of claim 34, wherein the means for registering the device for use with a service based on the identifier comprises means for creating an account for use with the service, the account being associated with the identifier of the device.

42. The system of claim 31, wherein the registration server further comprises means for transmitting to the device a registration confirmation message confirming the registration performed by the means for registering the device.

43. The system of claim 31, wherein the device comprises a printer.

44. A registration server for registering a device, the registration server comprising:
means for receiving a registration request message from the device, wherein the registration request message does not include information identifying a user of the device; and
means for registering the device based on the registration request message.

45. The registration server of claim 44, wherein the means for registering the device comprises:
means for obtaining an identifier of the device; and
means for registering the device based on the identifier.

46. The registration server of claim 45, wherein the registration request message includes the identifier of the device, and wherein the means for obtaining the identifier of the device comprises means for obtaining the identifier from the registration request message.

47. The registration server of claim 45, wherein the means for obtaining the identifier of the device comprises means for assigning the identifier to the device, and wherein the registration server further comprises means for transmitting the assigned identifier to the device.

48. The registration server of claim 44, further comprising:
means for determining whether the device is registered; and
wherein the means for registering the device comprises means for registering the device only if the device is not registered.

49. The registration server of claim 44, wherein the registration request message comprises a message requesting that the device be registered.

50. The registration server of claim 44, wherein the step (B) comprises a step of registering the device for use with a service, and wherein the registration request message comprises a message requesting initiation of a transaction with the service.

51. The registration server of claim 44, wherein the means for registering the device comprises means for recording the identifier of the device.

52. The registration server of claim 45, wherein the means for registering the device for use with the server based on the identifier comprises means for creating an account for use with a service, the account being associated with the identifier of the device.

53. The registration server of claim 44, further comprising:
means for transmitting to the device a registration confirmation message confirming the registration performed by the means for registering the device.

54. The registration server of claim 44, wherein the device comprises a printer.

55. A device comprising:
means for transmitting a registration request message to a registration server in response to input provided by a user of the device, wherein the input does not include information identifying the user; and
means for receiving from the registration server a registration confirmation message confirming that the device has been registered.

56. The device of claim 55, wherein the input comprises performance of only a single action by the user.

57. The device of claim 55, wherein the input comprises the pressing of a button on the device.

58. The device of claim 55, wherein the registration request message comprises a message requesting that the device be registered.

59. The device of claim 55, wherein the step (B) comprises a step of registering the device for use with a service, and wherein the registration request message comprises a message requesting initiation of a transaction with the service.

60. The device of claim 55, wherein the device comprises a printer.
